(19) United States
(12) Patent Application Publication
(10) Pub. No.: US 2013/0041756 A1
(43) Pub. Date: Feb. 14, 2013

(54) METHODS AND SYSTEMS FOR COLLECTION AND USE OF WIRELESS APPLICATION ACTIVITY INFORMATION

(71) Applicants: Pierre Carion, La Jolla, CA (US); Philippe Clavel, La Jolla, CA (US)

(72) Inventors: Pierre Carion, La Jolla, CA (US); Philippe Clavel, La Jolla, CA (US)

(21) Appl. No.: 13/526,476

(22) Filed: Jun. 18, 2012

Related U.S. Application Data
(63) Continuation of application No. 13/215,180, filed on Aug. 22, 2011, now abandoned.
Application No. 13/215,180 is a continuation of application No. 11/977,229, filed on Oct. 23, 2007, now abandoned.

(51) Int. Cl. G06Q 30/02

(52) U.S. Cl. 705/14.64

(57) ABSTRACT

A method for targeting one or more users. User interaction with a wireless application is monitored. Information based on the user interaction is analyzed. Based on the analysis, one or more customizations of the application are determined in order to target users. The customizations are dynamically applied to the application.

### TECHNICAL FIELD

Embodiments of the present invention relate to the field of wireless communication systems. More particularly, embodiments of the present invention relate to a method and system for collecting and using wireless application activity information.

### BACKGROUND ART

The rapid growth and widespread use of wireless devices has resulted in business opportunities to provide wireless applications. Correspondingly, businesses need to find ways of deriving revenue from the wireless applications. One common method for deriving revenue is to provide advertising. The ability to target users with specific or tailored advertisements greatly increases the value of the advertisements and thereby allows software vendors to increase revenue.

One such source for targeting users is based on the user's activity. Conventional wireless applications are often developed independently by software vendors and as a result any activity or behavior information, if stored at all, is scattered across numerous software vendors. The widespread distribution of application activity makes aggregation and use of such data difficult. For example, a software vendor may develop a wireless application but build in no support for adding advertising or monitoring activity. Even if activity information is collected, the software vendor may not be willing to share the information and thus the information may be of limited value by itself.

Further, the scattered activity information may make it difficult to identify activity of an individual user. For example, where a user has purchased two independent applications which access different resources, the user may identify (e.g., login) him/herself to different resources and corresponding activity information may be maintained separately.

Thus, a need exists for a solution that allows collection of user activity information across applications. What is further needed is a way to integrate advertisements into the application based on the collected activity information.

### SUMMARY

Accordingly, a need has arisen to enable the collection of user activity information across one or more applications. Moreover, a need has arisen to use the collected activity information to integrate advertisements within applications. It will become apparent to those skilled in the art after reading the detailed description of the present invention that the embodiments of the present invention satisfy the above mentioned needs.

According to one embodiment, the present invention. is implemented as a method for targeting one or more users. The method includes monitoring user interaction with an application on a wireless device. A portion of the application may execute on a server. Information collected by monitoring user interaction is then analyzed. One or more application customizations are determined or selected to target users. The application is dynamically customized based on the customizations determined based on user interaction information. The application customizations may include, but are not limited to, changing or customizing the application and/or integrating advertisements according to user interaction.

In another embodiment of the present invention, the present invention is implemented as a method for tailoring applications. The method includes receiving a plurality of requests which may be made during the execution of a wireless application. Information is then collected from the plurality of requests (e.g., type of request, content selection, etc.). Based on the information collected from the requests, a targeted advertisement may be selected. The targeted advertisement is then presented to the user within the application (e.g., displayed in a banner area or toolbar).

In another embodiment, the present invention is implemented as a system for selecting advertisements. The system includes a monitoring component for monitoring client application activity which may result from client application execution on a wireless device. The system further includes an advertising library module for providing access to a plurality of advertisements. Based on the client application activity, an activity analyzing module determines behavior patterns. The behavior determined is then used by an advertisement selection module to select an appropriate advertisement from the advertising library module to be included within said client application. An application customization module tailors the application to include the selected advertisement.

In this manner, embodiments of the present invention facilitate collection of user activity and inclusion of advertisements to target users. Moreover, embodiments of the present invention allow customization of applications to make the applications more convenient and user-friendly to users. Thus, users and businesses benefit from a richer and more useable application experience.

### BRIEF DESCRIPTION OF THE DRAWINGS

FIG. 1 shows an exemplary communication system in accordance with one embodiment of the present invention including wireless clients and a remote server.

FIG. 2 shows an exemplary device block diagram in accordance with one embodiment of the present invention.

FIG. 3 shows an exemplary server block diagram in accordance with one embodiment of the present invention.

FIG. 4 shows an exemplary computer controlled flow diagram for targeting a user in accordance with one embodiment of the present invention.

FIG. 5 shows an exemplary computer controlled flow diagram of a server implemented method of tailoring applications in accordance with one embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternative, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “initiating” or “receiving” or “analyzing” or “generating” or “constructing” or “outputting” or “collecting” or “monitoring” or “outputting” or “storing” or “sending” or “receiving” or “identifying” or using” or “rendering” or “translating” or “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### EMBODIMENTS OF THE INVENTION

The increase in the number of wireless devices has created an opportunity for businesses to target wireless application users. However, conventional systems provide little, if any, support for collection and aggregation of user activity across applications. Embodiments of the present invention facilitate the collection of wireless user activity and correspondingly target wireless users based on the activity information. Embodiments of the present invention further allow customizations or changes to applications to be made based on the collected user activity. Customizations can include the insertion of advertisements into applications as well as changing applications for more convenient use. Thus, applications can be tailored for the benefit of both users and businesses.

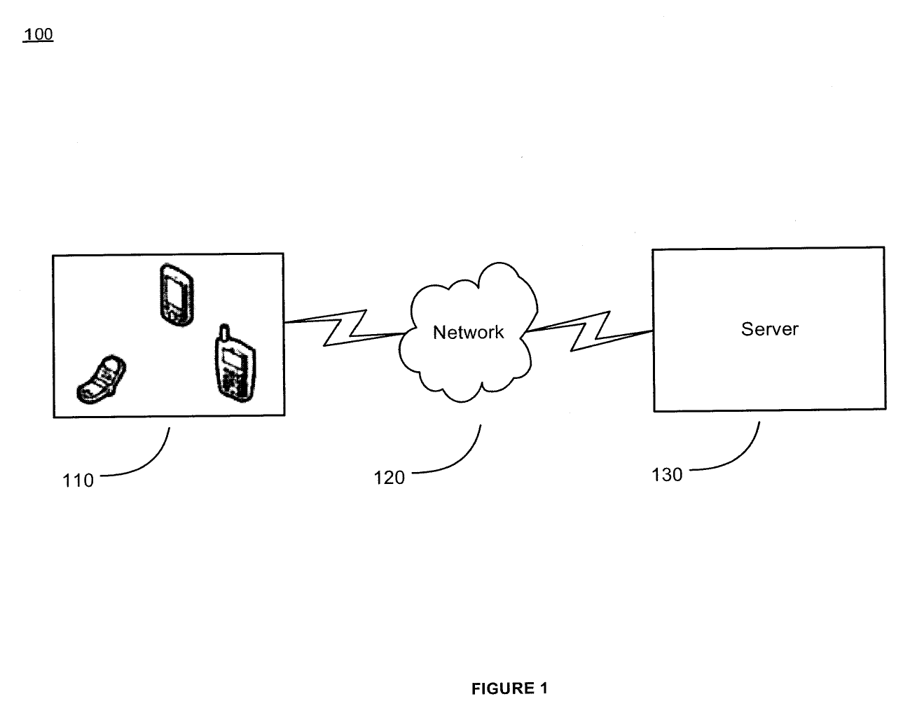

FIG. 1 shows an exemplary communication system in accordance with one embodiment of the present invention including wireless clients and a remote server. In one embodiment, one or more wireless devices 110 are coupled to a server 130 through a network 120. The wireless devices 110 may be any mobile wireless electronic device, e.g., a cellular phone, a personal digital assistant (PDA), a pager, a smart phone, a BlackBerry, a laptop and the like. It is appreciated that the wireless device described herein is exemplary and is not intended to limit the scope of the present invention. Network 120 includes wireless communication capability.

Remote server 130 may run generic applications which are customized for display on wireless devices 110. Thus, all the applications may run on a client which takes instructions from a server, which renders and executes relevant portions of the applications. The fact that applications are being run on the server means that all or most user activity is processed by the server and thereby can be recorded or stored on the server. For example, each request (e.g., menu or toolbar item selection, next screen, page, or the like) on a client (e.g., wireless devices 110) may be sent to a server (e.g., remote server 130) for processing and the server responds by providing the next page. User activity may be stored (e.g., on the server) in a plurality of ways including, but not limited to, databases and log files. Advantageously, embodiments of the present invention do not require additional client overhead because collection of activity and modification of applications are made on the server.

Embodiments of the present invention may use identification to maintain or track user activity across multiple applications. In one embodiment, the identification is based on user authentication when the client is started or during usage of the client. Thus, embodiments of the present invention provide automatic collection of user activity across multiple applications.

Embodiments of the present invention further facilitate acting upon analysis of the collected user activity. The analysis may be used to derive one or more user behaviors upon which to act. In one embodiment, user activity is used to provide targeted advertisements. For example, a user who routinely goes to the sports section of a news application may be presented with an advertisement to try a real-time sport application or a fantasy football application. The advertisements may further include adding trial applications to an application list or presenting a pop up message advertising a trial of an application.

In one embodiment, the types of applications a user accesses may be sufficient and used to effectively target the user. For example, if the user uses three free applications related to poker, the user may be a prime candidate for a trial or advertisement of a blackjack application. In some cases, there may be little information from the usage of a single application but the tracking of multiple applications may yield useful information. For example, a user who uses one application to check sports and another to check stock prices, may be a candidate for an application which allows the user to quickly see both sports scores and stock prices.

The analysis of user activity may further be used to dynamically change the application. For example, each time a user opens a news application he may check the sports information section first. Based on analysis of this behavior, a link to the sport information or the sports information may be put on the first page of the news application. Further, application toolbars and menus may be customized based on a user's activity. Referring to the above example, the link to the sports page may be moved forward or up in a toolbar or menu respectively.

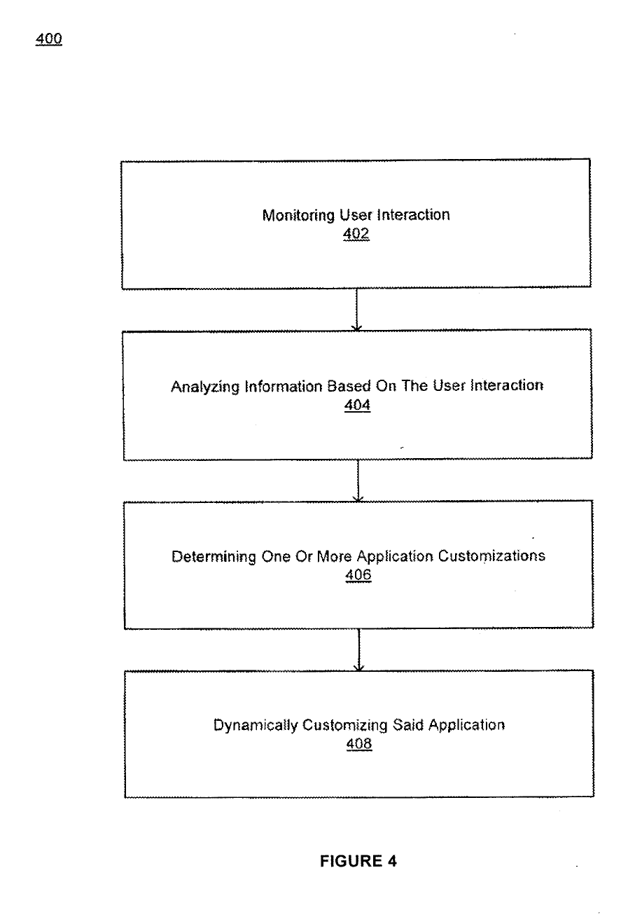

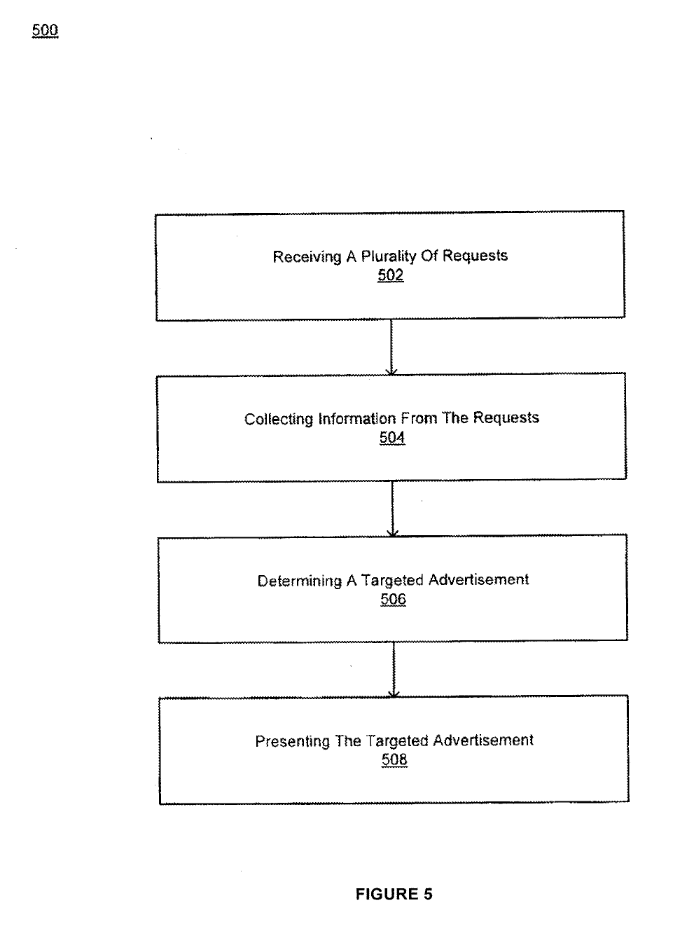

FIG. 2 shows an exemplary device block diagram in accordance with one embodiment of the present invention. Computing system environment 200 may implement a process for targeting users and tailoring applications as shown in FIGS. 4 and 5 and includes a bus 216 or other communication mechanism for communicating information, and a processor 202 coupled with bus 216 for processing information.

With reference to FIG. 2, an exemplary system for implementing embodiments includes a general purpose computing system environment, such as computing system environment 200. Computing system environment 200 may include, but is not limited to, desktop computers and servers. In its most basic configuration, computing system environment 200 typically includes at least one processing unit 202 and memory 204. Depending on the exact configuration and type of computing system environment, memory 204 may be volatile (such as RAM), non-volatile (such as ROM, flash memory, etc.) or some combination of the two. Computing system environment 200 may further include additional storage media as illustrated in FIG. 2 by non-removable storage 206 and removable storage 208. Computer storage media includes volatile and nonvolatile, removable and non-removable media implemented in any method or technology for storage of information such as computer readable instructions, data structures, program modules or other data.

Communications connection(s) 210 may allow computing system environment 200 to communication over various networks types including, but not limited to, Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 210 connect to may run a plurality of network protocols including, but not limited to, transmission control protocol (TCP), internet protocol (IP), and hypertext transfer protocol (HTTP).

The term “computer-readable medium” as used herein refers to any medium that participates in providing instructions to processor 202 for execution. Such a medium may take many forms, including but not limited to, non-volatile media, volatile media, and transmission media. Non-volatile media includes, for example, optical or magnetic disks or the like. Volatile media includes dynamic memory and the like.

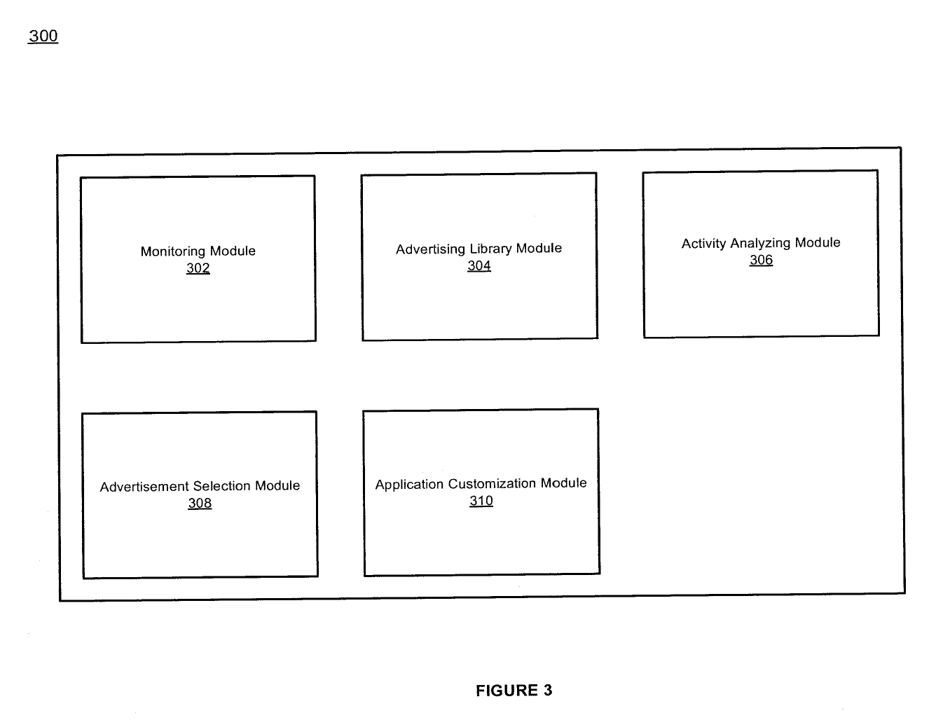

FIG. 3 illustrates example components used by various embodiments of the present technology for targeting users and tailoring applications. System 300 includes components or modules that, in various embodiments, are carried out by a processor under the control of computer-readable and computer-executable instructions. The computer-readable and computer-executable instructions reside, for example, in data storage features such as computer memory 204, removable storage 208, and/or non-removable storage 206 of FIG. 2. The computer-readable and computer-executable instructions are used to control or operate in conjunction with, for example, processing unit 202 of FIG. 2. It should be appreciated that the aforementioned components of system 300 can be implemented in hardware or software or in a combination of both. Although specific components are disclosed in system 300 such components are examples. That is, embodiments are well suited to having various other components or variations of the components recited in system 300. It is appreciated that the components in system 300 may operate with other components than those presented, and that not all of the components of system 300 may be required to achieve the goals of system 300.

FIG. 3 shows an exemplary server block diagram in accordance with one embodiment of the present invention. System 300 may implement a process for targeting users and/or tailoring applications. It is appreciated that system 300 may be executed on a system independent of a wireless carrier or service provider. System 300 may also be integrated into the offerings of a wireless service provider. System 300 includes monitoring module 302, advertising library module 304, activity analyzing module 306, advertisement selection module 308, and application customization module 310.

Monitoring module 302 monitors client application activity. As described herein, a client application executes on a wireless device and a substantial portion of application execution takes place on the server. In one embodiment, monitoring module 302 is able to monitor and record user requests (e.g., for links or URLs, applications, etc.) as a server handles the requests for a client application.

Advertising library module 304 provides access to a plurality of advertisements. In one embodiment, a plurality of advertisements is stored in a database and access to the advertisements is provided by advertising library module 304. Advertising library module 304 may also store and/or provide information associated with the advertisements (e.g., target user aspects or properties, behavior, or demographics). It is appreciated that advertisements and associated information may be stored locally or remotely with regard to system 300.

Activity analyzing module 306 determines behavior patterns or trends based on client application activity. In one embodiment a variety of resources accessed by the user may be analyzed including, but not limited to, applications, links (e.g., URLs), RSS feeds, music charts, news items, and team scores. For example, the type of RSS feeds may be used to determine the user is a particular type of sports fan (e.g., college football fan). Similarly, the user's repeated navigation to the college sports scores page may indicate the user is a college sports fan. The behavior patterns derived from the activity information may then be used to tailor applications and target users.

Customization selection module 308 selects customizations based on behavior patterns and heuristics. In one embodiment, customization selection module 308 selects advertisements (e.g., images, links, or splash screens) from advertising library module 304 to be included within the client application. For example, when a RSS feed is selected within an application, the type of RSS (e.g., music news, music charts) may be used to select an advertisement (e.g., an advertisement for streaming audio of the billboard top 40). In one embodiment, the advertisement may be a link, pop up message, text message (e.g., SMS message), image, or the like.

Application customization module 310 tailors an application to include selected advertisements. In one embodiment, application customization module 310 dynamically tailors the application to include advertisements. The selected advertisement may include a trial offer for a related or targeted application. The advertisement may be a pop up message, a splash screen, or Short Message Service (SMS) message. For example, an advertisement for seven card stud may be presented to a user who frequently uses a texas hold 'em poker application. In one embodiment, the server supports pausing the current application so a user may perform other tasks such as following a link in an advertisement to purchase or try a new application.

In one embodiment, advertisements may be integrated into the application itself such as to provide product placement. For example, an object such as a playing card, a football, or playing field may have the logo of a sports drink.

In another embodiment, the advertisement may be on a separate page or screen of an application. For example, a screen or page may be inserted in a news application between articles which contains a link to allow the user to skip the advertisement or view the advertisement (e.g., video, image, or the like).

In yet another embodiment, application customization module 310 may also push an application to a phone. The wireless device may request a list of applications upon startup and receive (e.g., via a push) information related to the new applications. For example, a trial of an application may be pushed to the wireless device for presentation to a user during the listing of applications. In another example, a splash screen may be presented when the user arrives at a list of applications which notifies the user a new application is available and he/she may try the application free for thirty days. The splash screen may contain options for a user to access the new application or continue to the list of applications. It is noted that no user interaction is required to receive the new application.

Different blocks have been described as separate units. However, it is appreciated that each functional unit described herein may be integrated as a single working unit. As such, depiction of functional units as separate units is exemplary and should not be construed as limiting the scope of the present invention.

With reference to FIGS. 4 and 5, flowcharts 400 and 500 each illustrate example blocks used by various embodiments of the present technology which sets forth in detail the operations of the present technology for targeting users. Flowcharts 400 and 500 include processes that, in various embodiments, are carried out by a processor under the control of computer-readable and computer-executable instructions. The computer-readable and computer-executable instructions reside, for example, in data storage features such as computer memory 204, removable storage 208, and/or non-removable storage 206 of FIG. 2. The computer-readable and computer-executable instructions are used to control or operate in conjunction with, for example, processing unit 202 of FIG. 2. Although specific blocks are disclosed in flowcharts 400 and 500, such blocks are examples. That is, embodiments are well suited to performing various other blocks or variations of the blocks recited in flowcharts 400 and 500. It is appreciated that the blocks in flowcharts 400 and 500 may be performed in an order different than presented, and that not all of the blocks in flowcharts 400 and 500 may be performed.

FIG. 4 shows an exemplary computer controlled flow diagram 400 for targeting one or more users in accordance with one embodiment of the present invention. The blocks of flowchart 400 may be carried out by a computing system (e.g., computing system environment 200) acting as a server. Blocks of flowchart 400 may be carried out or executed by software based units (e.g., modules or components of system 300).

At block 402, application usage is monitored. Application usage monitoring may be carried out by a software based unit (e.g., monitoring module 302). In one embodiment, the application is a wireless application. As described herein, the application may be executed primarily on a server and displayed on a client and thus requests are recorded, collected, and monitored on the server. It is further appreciated that embodiments are well suited to multiplayer games such as poker where a server may host a Texas hold'em poker game for multiple players. For example, a poker application may be executed on a server with drawing or rendering instructions transmitted to the phone for display the appropriate screen (e.g., dealing of cards). A user may thus enter a bet which is transmitted to the server where it is recorded and appropriate rendering instructions are sent to the phones of all players to update the screens accordingly.

At block 404, application usage information is analyzed. Application usage information may be analyzed or examined by a software unit (e.g., activity analyzing module 306). The user interaction examined may include repeated user actions (e.g., to the same news section or sports team page), type of application (e.g., sports, card games, or financial information applications), user navigation through an application and advertisements interaction (e.g., which types of advertisements a user responds to most often). In one embodiment, the application usage information may be based on the aggregated usage of several applications or several users. As mentioned herein, the user interaction of several users may be stored corresponding to an associated account which is verified by authentication when users start applications. For example, a pattern of user purchasing or playing certain card games may be recorded during the analysis of usage information. Such a pattern may be used to select applications that similar users have purchased. Similarly, a pattern of navigation within an application may be observed among several users. For example, if a group of users may exhibit a pattern of navigation to a certain story in a world news page of an news application. The analysis may further take into account or consideration user interaction with the user interface (e.g., menu items, toolbars, tabs, text inputs, input boxes, navigation, and the like) and type of application (e.g., sports, news, and weather). In one embodiment, analysis may be performed on data structure (e.g., stacks, heap, or the like) which stores a user's navigation history or other user interface interaction. For examples, if a user (or plurality of users) consistently opens a news applications then proceeds to the sports section and the college sports section, the user is creating a pattern of data within a navigation data structure and thus analysis may determine that the user is a college sports fan.

At block 406, one or more customizations based on the analysis of user interaction are determined. Customization determination or selection may be performed or carried out by a software based unit (e.g., customization selection module 308). In one embodiment, the customizations are selected to target one or more users based on the analysis of monitored user interaction. The customizations may be chosen based on a plurality of heuristics which take into account a variety of user interaction.

In one embodiment, the customization may include changing the look of an application, the arrangement of objects in the application, or delivery (e.g., via push) of a new application to the wireless device. For example, a user who routinely checks the college sports scores may have a customization determined which when applied will move the college sports scores to the front page or screen of an application.

As described herein, a pattern of navigation of several users may be used to determine an customization to change the layout, menus (e.g., arrangement or colors), or order of items within an application. The patterns of several users may be classified and a corresponding customization may include adding a trial period for a new application to each of the users' accounts. It is appreciated that the determination of a customization may further take into account available demographic information to target users. For example, a group of male users of the age group fifteen to twenty-four years old may have a group of trial card games added to their accounts.

The customization determined may further include adding or integrating advertisements to the applications, as described herein. Advertisements may be selected from an advertisement library or database (e.g., advertising library module 304). The advertisement may be included in an image, text, SMS, splash screen, link or the like. For example, advertisements may be added to a banner or toolbar area. The advertisements may further include advertisements for other applications as well as other resources available via the wireless device including, but not limited to, such as skins, ringtones, or Internet sites.

In one embodiment, the user may be able to access other applications without interrupting the current application and thereby pausing the current application on the server. For example, the server may save application state information (e.g., stack, heap, user settings, application settings, etc.) which allows the user to pick up or resume right where he/she was prior to accessing the other application or advertisement. It is appreciated that embodiments of the present invention may operate in conjunction with a server which executes the application (e.g., a generic application), prepares, and tailors output (e.g., rendering commands) for a client (e.g., wireless device) which displays the results of the rendering commands. Thus, the server may pause or suspend a first or currently executing application being displayed on the client and allow the client to display or execute a new program without any loss of flow or information of the first application.

At block 408, the application is dynamically customized based on a determined one or more customizations. Application customization may be performed or carried out by a software unit (e.g., application customization module 310). The customization of an application may include moving around or rearranging user interface elements such as links, pages, tabs, toolbars, and menu items. In the case where the customization is an advertisement, the advertisement may be inserted into an application (e.g., banner, border, or pop up message). An application can also be customized or modified to include a splash screen which may include an advertisement (e.g., for another application). It is appreciated that multiple customizations may be carried out or applied at the same time. For example, an advertisement may be displayed via a splash screen and an application may be added to an application list. In another embodiment, a dynamic toolbar may be customized to include the most recently used items. The customizations can advantageously be done on the fly and do not require developers to build in support for advertisements or other application changes. Conventional approaches would require a developer to redesign the application.

FIG. 5 shows an exemplary computer controlled flow diagram of a server implemented method for tailoring applications to include advertisements in accordance with one embodiment of the present invention. The blocks of flowchart 500 may be carried out by a computing system (e.g., computing system environment 200) acting as a server. Blocks of flowchart 500 may be carried out or executed by software based units (e.g., modules or components of system 300). It is appreciated flowchart 500 may represent a more specific embodiment of flow diagram 400. For example, flowchart 500 may tailor an multiplayer poker application to include advertisements.

At block 502, a plurality of requests is received. The requests may be made via a wireless device (e.g., cellular telephone) from the execution of a wireless application by one or more users. In one embodiment, as described herein, the wireless application may be displayed on a wireless device and a portion of the application execution is performed by a server. The requests may further result from user input or interaction such as selection of a variety of application objects including, but not limited to, navigation links, menus, menu items, toolbars, buttons, and icons. The plurality of requests may further originate from a plurality of wireless applications. Thus, the request may be from multiple users and/or multiple applications. For example, one or more users may play each other (possibly along with various computer based opponents) in a poker application and the corresponding actions by the users are received by a server during a poker game between each player.

At block 504, information from the requests is collected. The request information can be collected under control of a software based module or unit (e.g., monitoring module 302). The information may be collected on a server (e.g., computing system environment 200) via an application (e.g., system 300) which executes primarily on a server and sends corresponding rendering instructions to a client device (e.g., cellular telephone). Each user interaction may then be transmitted to the server as a request to carry out the request (e.g., next screen/page, submission of information). Thus, because the requests for each application are received by the server and corresponding output is sent to the client device, the server facilitates the collection, recording, and storage of requests of users. The server can also associate the user interaction or requests with a specific user or user account by requiring authentication at the launch of each application or during execution. Collecting request information on the server further facilities centralized storage and centralized administration (e.g., request tracking or monitoring properties, updating advertisement selection preferences, advertisements, advertisement format and placement updates, software updates, etc.). Collection of information across multiple applications is thereby possible because each application requires interaction with the server. For example, each move or play of a multiplayer poker game may be sent to the server for processing and updating of the game information or state (e.g., current bet, players left, pot size) and thereby collected and recorded.

The request information can then be stored in a variety of ways, including but not limited to, a database, logs, XML data stores which may be indexed in a variety of ways including, but not limited to, user accounts, applications, time/date of access in real time. The information may include the menus and menu items user select as well as links and icons, links, and pages. The information may further include content specific information such as a information contained in a link, RSS feed, or page. For example, the fact that an RSS feed is for a specific baseball team may be collected and/or recorded.

At block 506, a targeted advertisement is determined. As described herein, the targeted advertisement may be determined (e.g., by activity analyzing module 306 and customization selection module 308) based on the information collected (e.g., by monitoring module 302). For example, if a group of users often play Texas hold 'em poker, a banner advertisement to target the users in the texas hold 'em poker application may be determined or selected for display. In another embodiment, the targeted advertisement may be determined based on aggregation of information for a plurality of applications. For example, a card game or poker event advertisement may be determined or selected for a user who plays multiple card games. The targeted advertisement may also be determined based on the requests of a plurality of users. For example, a plurality of users who regularly check football scores may be selected to receive an advertisement for a fantasy football application.

At block 508, the targeted advertisement is presented. The presentation of the targeted advertisement may be carried out by a software unit (e.g., application customization module 310). In one embodiment, the targeted advertisement is presented in a wireless application. As described herein, the advertisement may be presented in a plurality of ways including, but not limited to, a banner, toolbar, splash screen, text message (e.g., SMS message), or text box. The advertisement may also be presented to a plurality of users at the same time. For example, a group of five users playing against each other in a poker application may be simultaneously be presented with a banner advertisement for a blackjack application, an enhanced poker application, or have a freeware trial added to their accounts.

Accordingly, user activity is collected and applications are tailored based on user activity. Users benefit from having applications tailored to make them more convenient and receiving trials of applications. Advertisers and businesses benefit from the opportunity to target users in an effective manner and thereby derive revenue. Moreover, embodiments of the present invention require little if any additional overhead.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method executed by a processor comprising:
monitoring user input associated with an application on a wireless device, said user input transmitted to a server;
analyzing the user input to detect a behavior pattern associated with a user's use of the application;
determining a customization of said application based on said behavior pattern analysis, said determining including establishing the location for display of said customizations of said applications on the wireless device; and
dynamically customizing said application based on said customization, with said customization displayed on the wireless device at the location established in said determining process.

2. The method of claim 1, wherein said dynamically customizing adds an advertisement to the application based on said behavior pattern.

3. The method of claim 1, wherein said application is executed on a server and rendered on a client device.

4. The method of claim 3, wherein said application is a generic application customized for display according to a capability of the client device.

5. The method of claim 1, wherein said dynamically customizing rearranges an order of information presented by a client device.

6. The method of claim 1, wherein said dynamically customizing includes dynamically customizing a dynamic tool bar.

7. The method of claim 1, wherein said application is a first application, said dynamically customizing said application includes presenting a splash screen including an advertisement for a second application related to the first application.

8. The method of claim 1, wherein said application is a first application, said dynamically customizing includes adding a second application to a wireless account associated with the user.

9. A non-transitory processor-readable medium comprising code representing instructions to cause a processor to:
Receive a plurality of requests associated with user navigation of an application executing on a wireless device;
analyze the plurality of requests to dynamically define a behavior pattern;
select a targeted advertisement based on said behavior pattern;
determine a location to display said targeted advertisement in said wireless application on said wireless device based on said behavior pattern; and
present said targeted advertisement in said application in said location.

10. The non-transitory processor-readable medium of claim 9, wherein said application is from a plurality of applications, said plurality of requests being associated with the plurality of applications.

11. The non-transitory processor-readable medium of in claim 9, wherein said application is a first application, the non-transitory processor-readable medium further comprising code representing instructions to cause the processor to:
receive a plurality of requests associated with user navigation of a second application executing on the wireless device, the code representing instructions to analyze including code representing instructions to cause the processor to analyze the first plurality of requests and the second plurality of requests to dynamically define the behavior pattern.

12. The non-transitory processor-readable medium of claim 9, wherein said targeted advertisement is a short message service (SMS) message.

13. The non-transitory processor-readable medium of claim 9, wherein said application is a first application, said targeted advertisement is an advertisement for a second application configured to be executed on the wireless device.

14. The non-transitory processor-readable medium of claim 9, wherein said wireless device is a first wireless device, the application is a first instance of the application, and the plurality of requests is a first plurality of requests, the non-transitory processor-readable medium further comprising code representing instructions to cause the processor to:
receive a second plurality of requests associated with user navigation of a second instance of the application executing on a second wireless device,
the code representing instructions to cause the processor to analyze including code representing instructions to cause the processor to analyze the first plurality of requests and the second plurality of requests to dynamically define the behavior pattern.

15. A system for selecting advertisements, comprising:
a monitoring module configured to monitor user input to a client application executing on a wireless device;
an advertising library module configured to provide access to a plurality of advertisements;
an activity analyzing module configured to determine, based on the user input to the client application, a behavior pattern;
an advertisement selection module configured to select an advertisement from said plurality of advertisements based on said behavior pattern; and
an application customization module configured to dynamically tailor said application to include said advertisement from said plurality of advertisements, said application customization module also determining the location for display of said advertisement on the wireless device .

16. The system of claim 15, wherein said advertisement includes a link.

17. (canceled)

18. (canceled)

19. The system of claim 15, wherein said behavior pattern includes a type of really simple syndication (RSS) feeds accessed using the wireless device.

20. The system of claim 15, wherein said advertisement includes a pop up message.

21. The method of claim 1, wherein the monitoring user input includes monitoring a number of times a user repeats an action associated with the application.

22. The non-transitory processor-readable medium of claim 9, wherein the code representing instructions to cause the processor to analyze includes code representing instructions to cause the processor to analyze the plurality of requests to determine a type of advertisement to which a user of the application most frequently responds.
